(19) United States
(12) Patent Application Publication
(10) Pub. No.: US 2021/0031394 A1
(43) Pub. Date: Feb. 4, 2021

(54) ADSORPTION POSITIONING DEVICE

(71) Applicant: POU CHEN CORPORATION, Chang Hwa Hsien (TW)

(72) Inventors: An LI, Taoyuan City (TW); Xin-Bo TAN, Bailian Town (CN); Dan-Dan LIU, Dongwuying Township (CN)

(73) Assignee: POU CHEN CORPORATION, Chang Hwa Hsien (TW)

(21) Appl. No.: 16/743,605

(22) Filed: Jan. 15, 2020

(30) Foreign Application Priority Data
Aug. 1, 2019 (TW) 108127408

(51) Int. Cl. B26D 1/04; B26D 7/00; B23K 26/38; B23K 26/70

(52) U.S. Cl. CPC B26D 1/04; B23K 26/702; B23K 26/38; B26D 2007/0012

(57) ABSTRACT

An adsorption positioning device suitable for installation on a cutting machine, which is suitable for cutting a material unit, includes a platform and two platen units. The platform includes a table for supporting the material unit, and a plurality of air holes extending through the table. The platen units are disposed on the table. The table and each platen unit are configured for cooperating with a lateral side of the material unit to define a channel that communicates with corresponding ones of air holes. The channel and the air holes are suitable for causing the material unit to be adsorbed on the table under a negative pressure state.

### CROSS-REFERENCE TO RELATED APPLICATION

This application claims priority to Taiwanese Patent Application No. 108127408, filed on Aug. 1, 2019.

### FIELD

The disclosure relates to a positioning device, more particularly to an adsorption positioning device that is suitable for use in a cutting machine.

### BACKGROUND

Referring to FIG. 1, a conventional cutting machine 1 mainly includes a platform 11 for placement of a material unit 2, and a cutting device 12 for cutting the material unit 2. The platform 11 has a plurality of air holes 111 communicating with a negative pressure device (not shown). Under a negative pressure state, the air holes 111 are used to generate adsorption forces to a bottom surface of the material unit 2, so that the material unit 2 can be positioned stably on the platform 11. The cutting device 12, such as a laser, a cutting knife, etc., is used to cut the material unit 2 for forming more than one surface material with a determined shape.

Although the cutting machine 1 can generate adsorption forces on the material unit 2 through the air holes 111, when the material unit 2 includes a plurality of stacked materials 21, usually, only the lowest layer of the materials 21 can be adsorbed and positioned. Particularly, when the materials 21 are made of an airtight material, it is easy to affect the cutting precision or cause the cutting to stop during the cutting process because of partial disconnection and floating or throwing situation.

To reduce the problem of floating and throwing of the materials 21, a releasable paper or plastic film is used to cover a top side of the material unit 2 for constructing a space capable of covering the entire material unit 2 in an airtight state so as to improve the overall adsorption effect. However, when the releasable paper or the plastic film is cut along with the materials 21 and is damaged, the airtight state is released, and the problem of floating and throwing of the materials 21 similarly exists. Further, the thrown portion will wind around the cutting device 12, thereby causing interruption of the cutting process.

### SUMMARY

Therefore, an object of the present disclosure is to provide an adsorption positioning device that is capable of alleviating at least one of the drawbacks of the prior art.

According to this disclosure, an adsorption positioning device is suitable for installation on a cutting machine. The cutting machine is suitable for cutting a material unit. The adsorption positioning device includes a platform and two platen units. The platform includes a table suitable for supporting the material unit, and a plurality of air holes extending through the table and communicating with an external environment. The platen units are disposed on the table and are spaced apart from each other along a first direction. Each platen unit extends along a second direction perpendicular to the first direction. The table and each platen unit are configured for cooperating with a lateral side of the material unit to define a channel that communicates with corresponding ones of the air holes. Each platen unit includes a platen having a press portion suitable for pressing the lateral side of the material unit. The channel and the air holes are suitable for causing the material unit to be adsorbed on the table under a negative pressure state.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a conventional cutting machine;

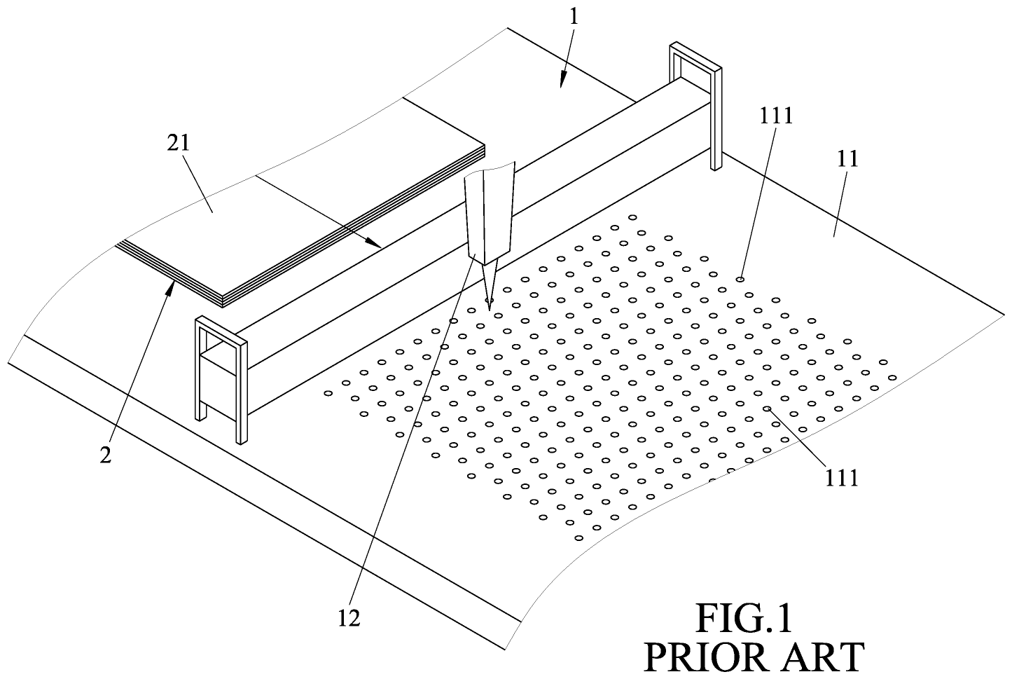

FIG. 2 is a fragmentary perspective view of an adsorption positioning device according to the first embodiment of the present disclosure;

FIG. 3 is an exploded perspective view of a platen unit of the first embodiment;

FIG. 4 is a fragmentary top view of the first embodiment;

FIG. 5 is a sectional view of the first embodiment taken along line V-V of FIG. 4;

FIG. 6 is a sectional view of the first embodiment taken along line VI-VI of FIG. 4;

FIG. 7 is an enlarged fragmentary sectional view of the first embodiment;

FIG. 8 is a view similar to FIG. 6, but with a change in heights of platens of platen units;

FIG. 9 is a view similar to FIG. 7, but with the platen unit further including a sealing member;

FIG. 10 is an exploded perspective view of a platen unit of an adsorption positioning device according to the second embodiment of the present disclosure;

FIG. 11 is a top view of the platen unit of the second embodiment in an assembled state; and

FIG. 12 is an enlarged fragmentary sectional view of the second embodiment.

### DETAILED DESCRIPTION

Before the present disclosure is described in greater detail, it should be noted herein that like elements are denoted by the same reference numerals throughout the disclosure.

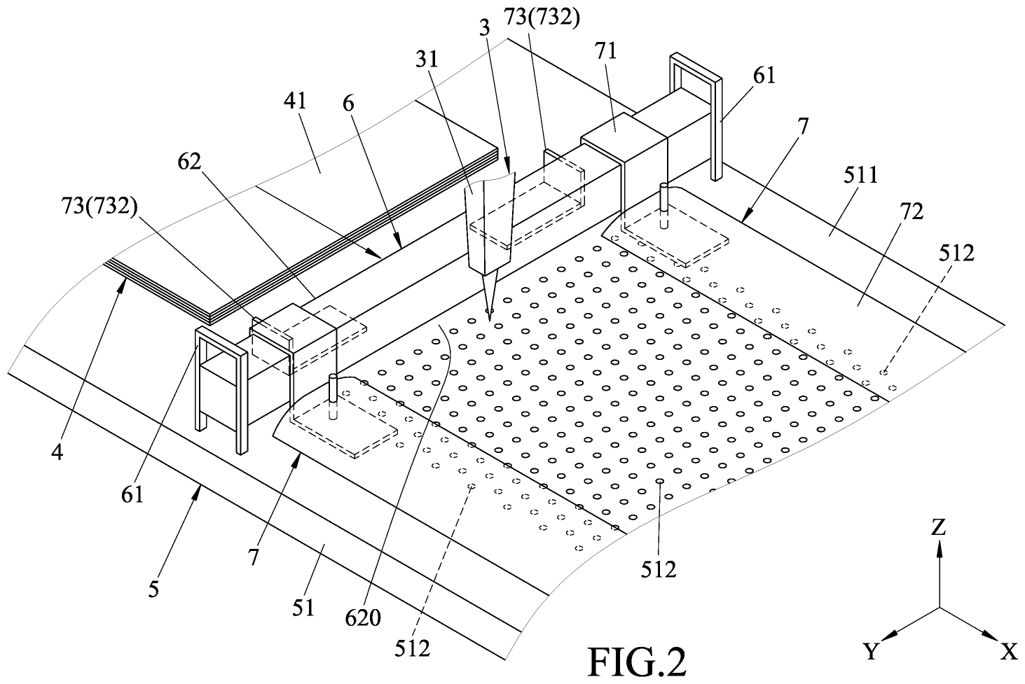

Referring to FIG. 2, an adsorption positioning device according to the first embodiment of this disclosure is suitable to be mounted on a machine frame (not shown) of a cutting machine 3. The cutting machine 3 is used for cutting a material unit 4, and includes a cutting device 31. The cutting device 31 cuts with a laser. The material unit 4 includes a plurality of materials 41 that are stacked along a stacking direction (Z) and that pass through the cutting machine 3. The adsorption positioning device includes a platform 5, a pressing rod unit 6, and two platen units 7.

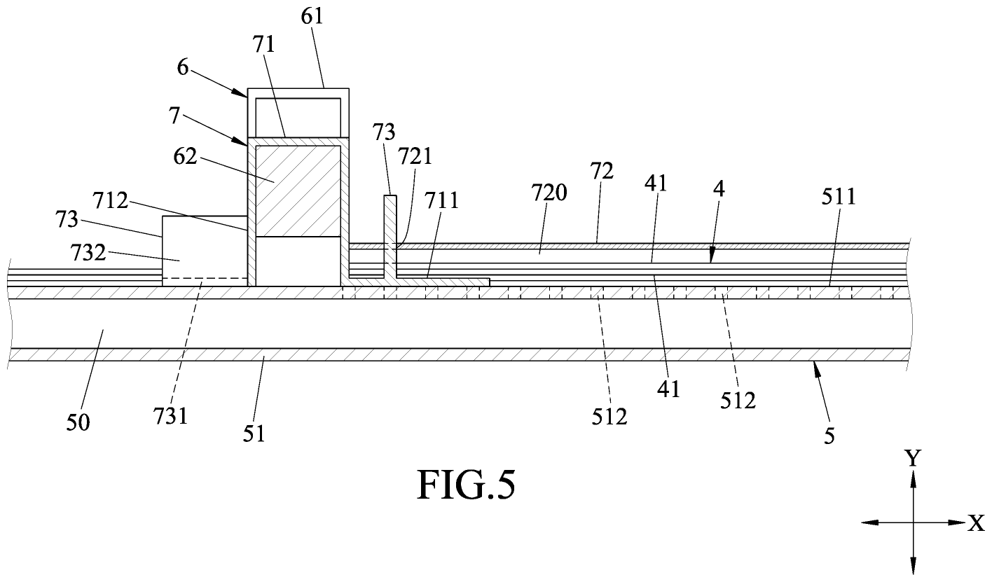

The platform 5 includes a chamber wall 51 defining a chamber 50 (see FIG. 5) that is suitable for communicating with a negative pressure device (such as a vacuum pump, not shown). The platform 5 further includes a table 511 that serves as the top of the chamber wall 51 and that is suitable for supporting the material unit 4, and a plurality of air holes 512 extending through the table 511 and communicating the chamber 50 with an external environment.

The pressing rod unit 6 is disposed on the table 511, and includes a pressing rod 62 extending along a first direction (Y) which is perpendicular to the stacking direction (Z), and two tracks 61 spaced apart from each other along the first direction (Y). The pressing rod 62 and the table 511 cooperatively define a feeding space 620 suitable for passage of the material unit 4 therethrough along a second direction (X) which is perpendicular to the first direction (Y) and the stacking direction (Z). The pressing rod 62 is movably disposed between the tracks 61 for adjusting a height of the feeding space 620. In this embodiment, the first direction (Y) is a width direction of the table 511, the second direction (X) is a length direction (X) of the table 511, and the stacking direction (Z) is a top-bottom direction.

In this embodiment, the pressing rod 62 is releasably fastened between the tracks 61 through fasteners (not shown). By changing the height of the feeding space 620 along the stacking direction (Z), the material unit 4 with a large change in thickness can smoothly pass through the feeding space 620. It should be noted herein that the pressing rod 62 is not limited to be releasably fastened between the tracks 61. In other variations of this embodiment, the tracks 61 may be omitted, and two pressure cylinders may be disposed on the table 511 for driving the pressing rod 62 to move along the stacking direction (Z), but is not limited thereto.

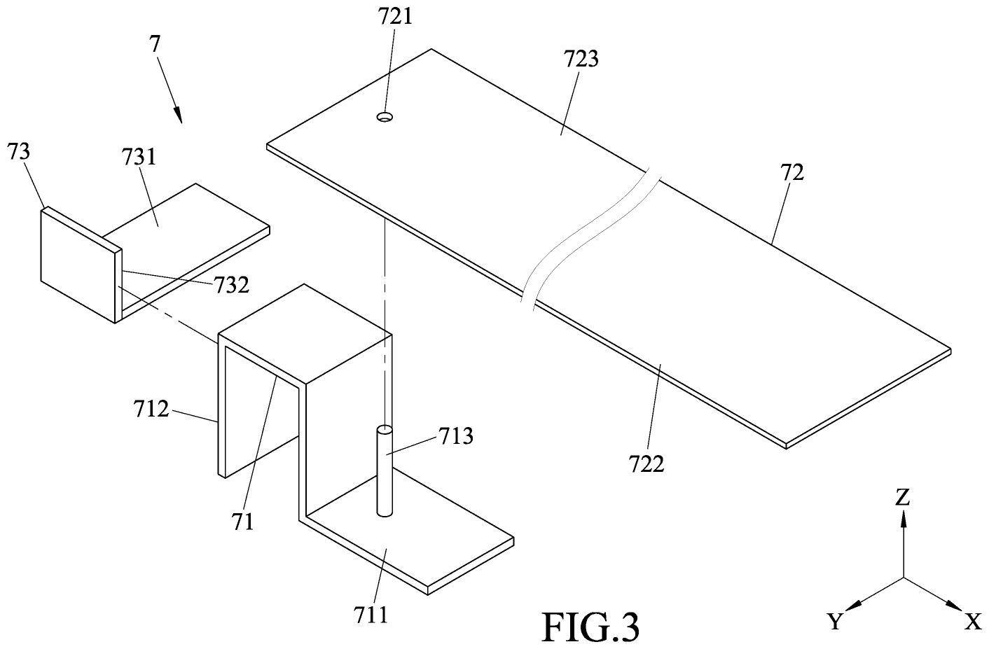

The platen units 7 are spaced apart from each other along the first direction (Y). Each platen unit 7 includes a slide member 71, a platen 72, and a guide member 73, as shown in FIG. 3. The slide member 71 is disposed on the pressing rod 62, is movable along the length of the pressing rod 62, and includes a first connecting portion 711 extending along the second direction (X), a second connecting portion 712 having an inverted-U shape and extending over the pressing rod 62, and a connecting pin 713 disposed on and extending upwardly from the first connecting portion 711.

The platen 72 extends along the second direction (X), and has a cover portion 722 and a press portion 723 adjacent to each other along the second direction (X), and a first pin hole 721 formed in the press portion 723 in proximity to one end thereof and distal to the cover portion 722. The platen 72 is connected to the first connecting portion 711 of the slide member 71 by extending the connecting pin 713 through the first pin hole 721. One side of the cover portion 722 that is distal to the press portion 723 abuts against the table 511. The press portion 723 is suitable for pressing a lateral side of the material unit 4.

The platen 72 is made of a material that is soft, resilient and resistant to deformation, such as PVC, paper, etc. The platen 72 of each platen unit 7 cooperates with the table 511 and a corresponding one of the lateral sides of the material unit 4 to define a channel 720 that communicates with corresponding ones of the air holes 512.

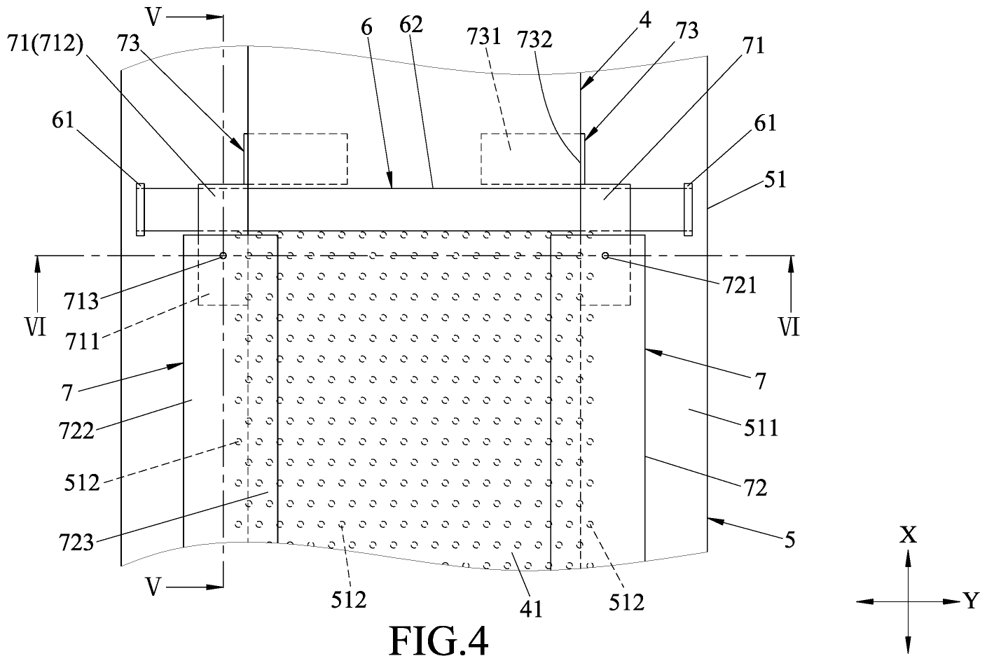

As shown in FIGS. 3 and 4, the guide member 73 is connected to the second connecting portion 712 opposite to the first connection portion 711, and has a supporting portion 731 and a limiting portion 732 perpendicularly intersecting each other. The supporting portion 731 is suitable for supporting a bottom surface of the material unit 4. The limiting portion 732 is suitable for facing and abutting against the lateral side of the material unit 4.

Referring to FIGS. 4 to 7, in combination with FIGS. 2 and 3, when the material unit 4 is driven to move on the table 511 of the platform 5 along a direction of an arrow shown in FIG. 2, the material unit 4 is guided by the limiting portions 732 of the guide members 73 of the platen units 7 to pass through the feeding space 620 to a position below the cutting device 31.

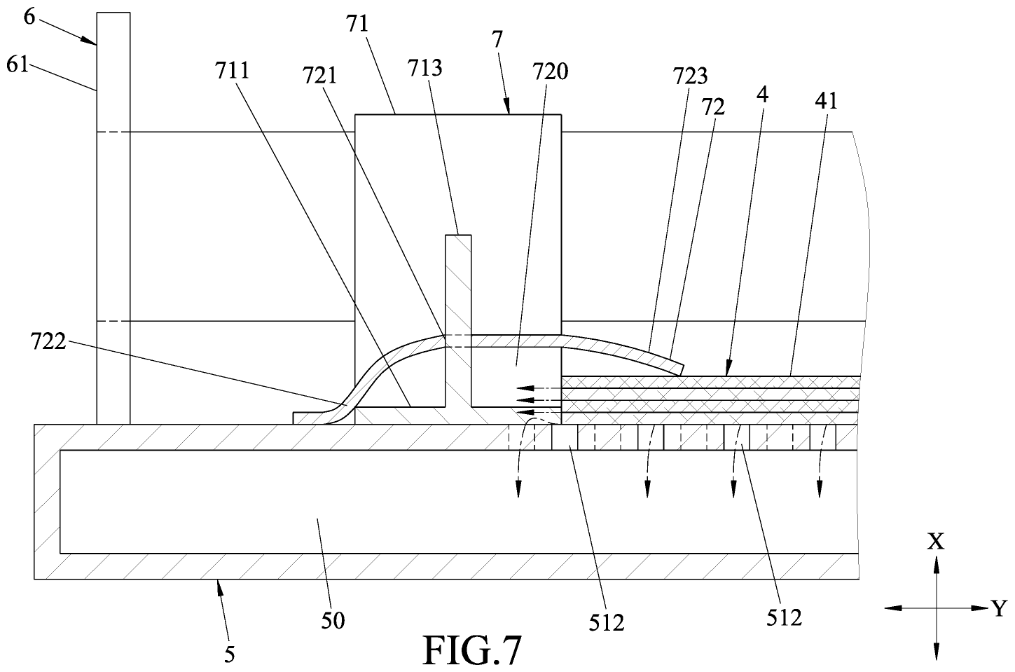

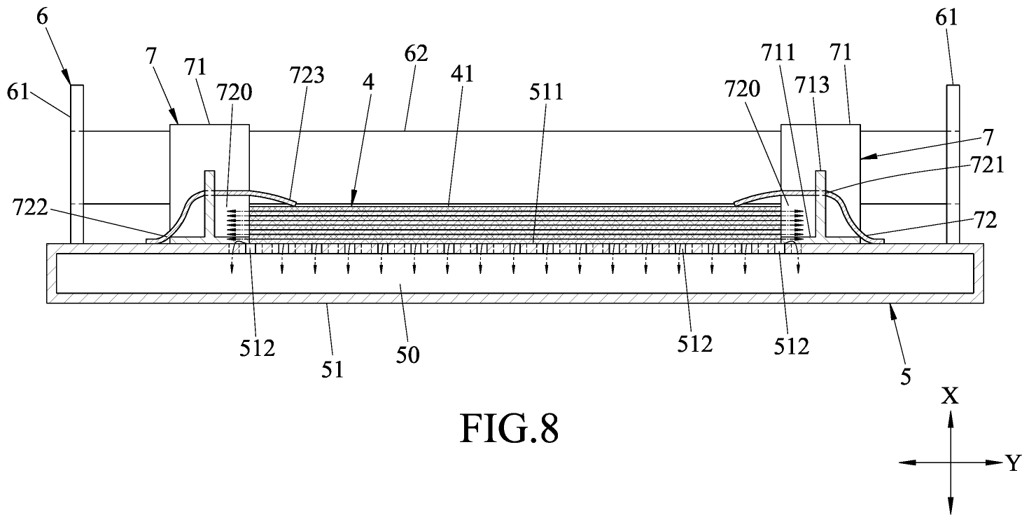

During cutting of the material unit 4 by the cutting device 31, through the negative pressure device (not shown), air current will flow, as shown by the arrows in FIGS. 7 and 8, from the bottom surface of the material unit 4 into the chamber 50 of the platform 5 through the air holes 512, and from lateral sides of the materials 41 of the material unit 4 to the channels 720 and into the chamber 50 through the air holes 512. Through this, the chamber 50, the air holes 512 and the channels 720 form a negative pressure state, and adsorption forces are generated on the materials 41 of the material unit 4, so that adjacent upper and lower materials 41 of the material unit 4 tightly abut against each other and are adsorbed on the table 51.

When the materials 41 are cut and partially broken, air current will flow from the partially broken parts and enter among the materials 41, and then enter the channels 720 through the lateral sides of the materials 41, and finally, enter the chamber 50 through the channels 720 and the air holes 512. Similarly, adsorption forces can be generated on the materials 41 of the material unit 4, so that the adjacent upper and lower materials 41 of the material unit 4 can tightly abut against each other and can be adsorbed on the table 511.

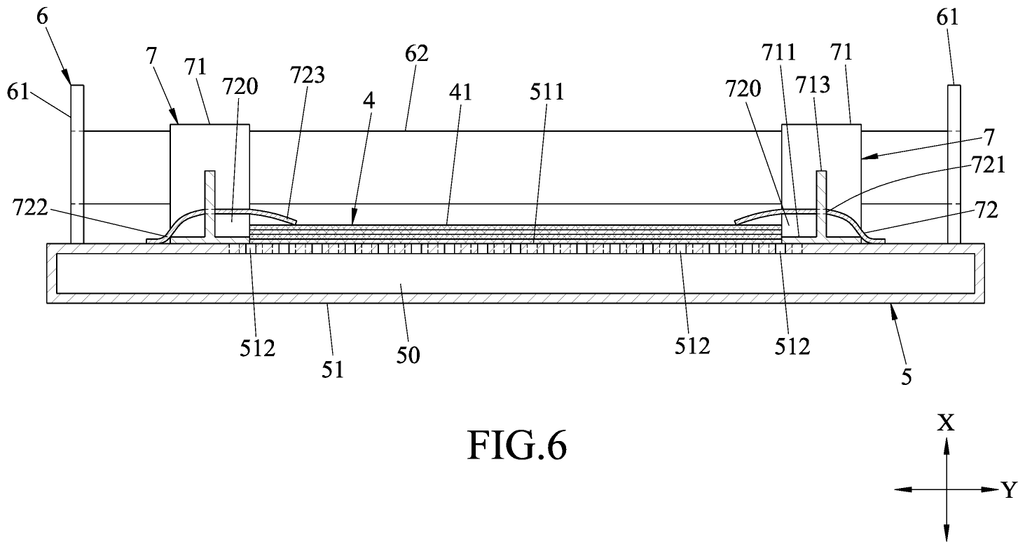

Referring to FIGS. 6 and 8, it is worth to mention herein that, since the platen 72 of each platen unit 7 is made of a soft material and is connected to the slide member 71 by extending the connecting pin 713 through the first pin hole 721, when the material unit 4 has a slight change in the thickness thereof and passes under the press portion 723 of the platen 72, the platen 72 will be pushed and squeezed by the material unit 4 to move upward along the stacking direction (Z), and automatically adjust its distance and height relative to the table 511. No matter how the height changes, by virtue of its softness, the platen 72 can make the cover portion 722 thereof to fall naturally and contact the table 511, and make the press portion 723 thereof to fall naturally and press the material unit 4. The platen 72 of each platen unit 7 can similarly cooperate with the table 511 and the corresponding lateral side of the material unit 4 to define the channel 720 that communicate with the air holes 512.

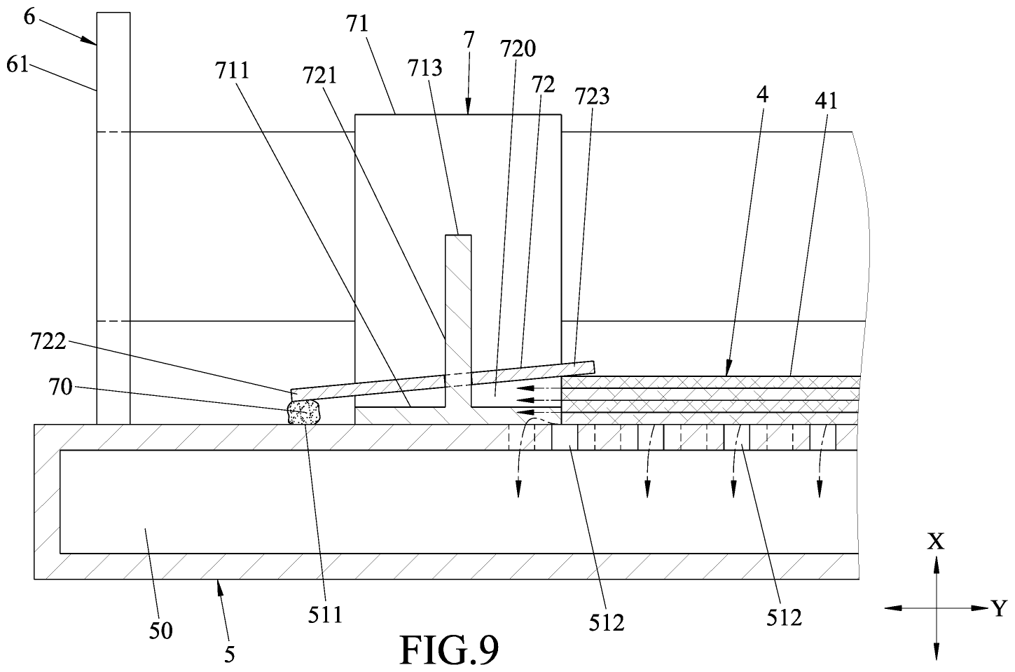

It should be noted herein that the cover portion 722 of the platen 72 of each platen unit 7 is not limited to fall naturally and contact the table 511. In other variations of this embodiment, the platen 72 may be soft and resilient, but is not easy to deform, and may be connected to the table 511. As shown in FIG. 9, each platen unit 7 further includes a sealing member 70, which may be an adhesive tape, glue, or other structure, that can bind the table 511 and the platen 72. Through this, the cover portion 722 of the platen 72 is fixed to the table 511, thereby further increasing the airtight effect.

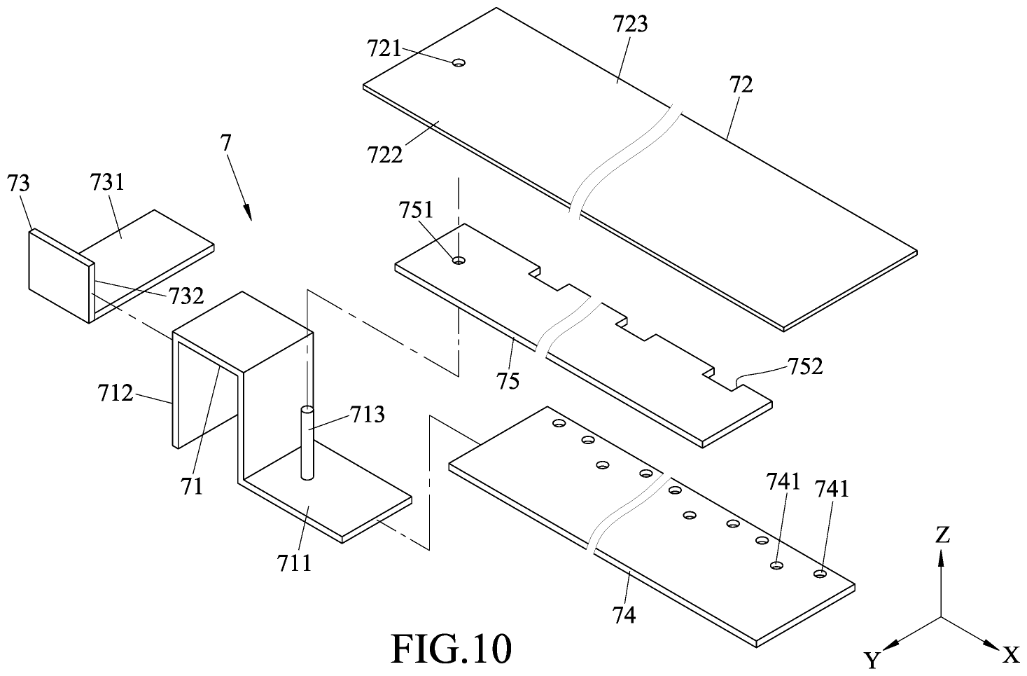

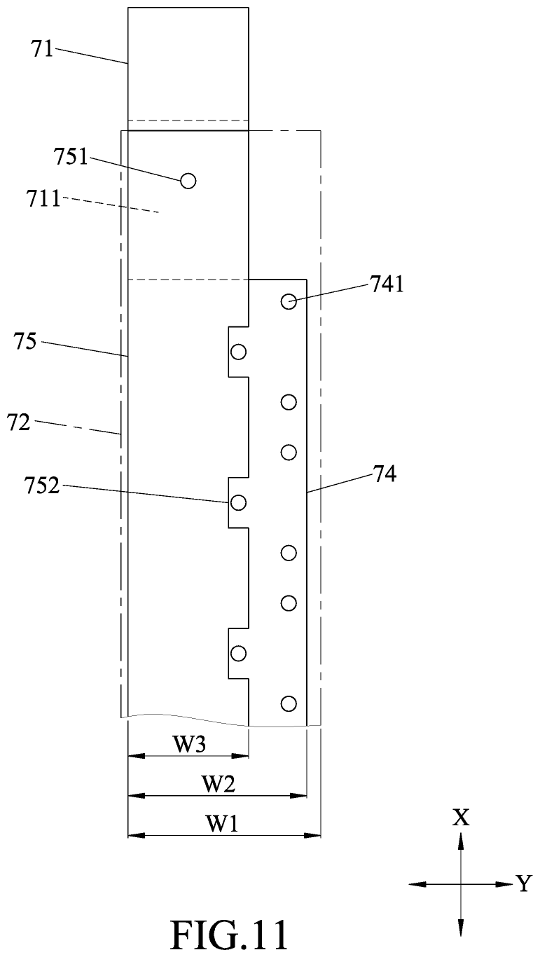

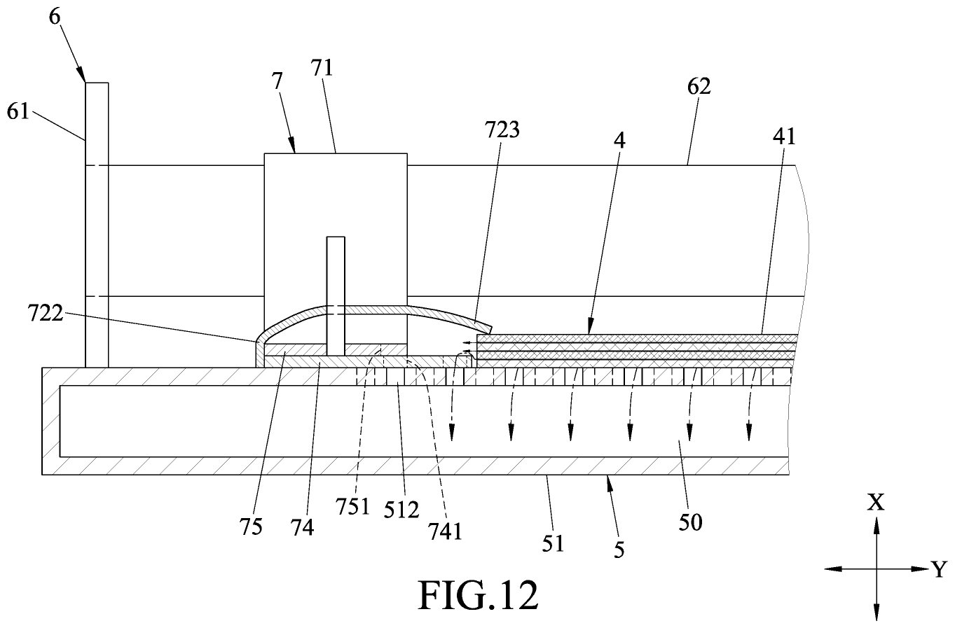

Referring to FIGS. 10 to 12, the second embodiment of the adsorption positioning device of this disclosure is shown to be identical to the first embodiment. Particularly, the adsorption positioning device includes the platform 5, the pressing rod unit 6 and the platen units 7. However, in the second embodiment, each platen unit 7 further includes a first plate member 74 and a second plate member 75 stacked one above the other along the stacking direction (Z). The first plate member 74 and the second plate member 75 are disposed between the platen 72 and the table 511.

The first plate member 74 is disposed on the table 511 of the platform 5, and has a plurality of perforations 741 communicating with the corresponding ones of the air holes 512. The second plate member 75 has a second pin hole 751 proximate to one end thereof, and a plurality of notches 752 formed on one lateral side thereof that faces the material unit 4. The second plate member 75 is connected to the first connecting portion 711 of the slide member 71 by extending the connecting pin 713 through the pin hole 751. The notches 752 communicate with the channel 720 and the corresponding ones of the perforations 741.

The width (W1) of the platen 72 along the first direction (Y) is larger than the width (W2) of the first plate member 74 along the same direction. The width of the first plate member 74 is, in turn, larger than the width (W3) of the second plate member 75 along the first direction (Y). Through this, the platen 72 can cover the first plate member 74 and the second plate member 75, and the notches 752 can expose the perforations 741.

Apart from supporting the platen 72, the first plate member 74 and the second plate member 75 that are stacked along the stacking direction (Z) can further prevent the platen 72 from shrinking and deforming when the chamber 50, the air holes 512 and the channel 720 form a negative pressure state, so that the platen 72 will not block the air holes 512, and smooth flow of the air current can be maintained.

From the foregoing, the advantages of this disclosure can be summarized as follows:

1) This disclosure can use the channels 720 and the air holes 512 disposed in the negative pressure state to generate adsorption forces relative to the bottom side and the lateral sides of the material unit 4, so that the material unit 4 can be firmly adsorbed on the table 511 to facilitate the processing of the material unit 4. Through this, stability of processing the material unit 4 can be enhanced, and the processing quality and smoothness can also be improved.

2) The platen 72 of each platen unit 7 can automatically adjust its distance and height relative to the table 511 to match the thickness of the material unit 4, and can also match the width of the material unit 4 by adjusting the distance between the platen units 7. Further, this disclosure is applicable for the material unit 4 with different thicknesses and different widths, so that convenience in use and practicality of this disclosure can be improved.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An adsorption positioning device suitable for installation on a cutting machine, the cutting machine being suitable for cutting a material unit, said adsorption positioning device comprising:
a platform including a table suitable for supporting the material unit, and a plurality of air holes extending through said table and communicating with an external environment; and
two platen units disposed on said table and spaced apart from each other along a first direction, each of said platen units extending along a second direction perpendicular to the first direction, said table and each of said platen units being configured for cooperating with a lateral side of the material unit to define a channel that communicates with corresponding ones of said air holes, each of said platen units including a platen that has a press portion suitable for pressing the lateral side of the material unit, said channel and said air holes being suitable for causing the material unit to be adsorbed on said table under a negative pressure state.

2. The adsorption positioning device as claimed in claim 1, wherein said platen further has a cover portion adjacent to said press portion, said cover portion having one side that is distal to said press portion abutting against said table.

3. The adsorption positioning device as claimed in claim 1, further comprising a pressing rod unit that is disposed on said table and that includes a pressing rod, said platen units being connected to said pressing rod, said pressing rod and said table cooperatively defining a feeding space suitable for passage of the material unit therethrough along the second direction.

4. The adsorption positioning device as claimed in claim 3, wherein said pressing rod unit further includes two tracks spaced apart from each other along the first direction, said pressing rod being movably disposed between said tracks for adjusting a height of said feeding space.

5. The adsorption positioning device as claimed in claim 3, wherein each of said platen units further includes a slide member that is disposed on said pressing rod, that is movable along a length of said pressing rod and that is connected to said platen.

6. The adsorption positioning device as claimed in claim 5, wherein said slide member includes a first connecting portion extending along the second direction, and a connecting pin disposed on and extending upwardly from said first connecting portion, said platen further having a first pin hole proximate to one end thereof and being connected to said first connecting portion by extending said connecting pin through said first pin hole.

7. The adsorption positioning device as claimed in claim 6, wherein said slide member further includes a second connecting portion extending over said pressing rod, each of said platen units further including a guide member that is connected to said second connecting portion and that has a supporting portion and a limiting portion perpendicularly intersecting each other, said supporting portion being suitable for supporting a bottom surface of the material unit, said limiting portion being suitable for abutting against the lateral side of the material unit.

8. The adsorption positioning device as claimed in claim 6, wherein each of said platen units further includes a first plate member and a second plate member stacked one above the other and disposed between said platen and said table, said first plate member having a plurality of perforations communicating with corresponding ones of said air holes, said second plate member having a plurality of notches formed on one lateral side thereof that faces the material unit and communicating with said channel and corresponding ones of said perforations.

9. The adsorption positioning device as claimed in claim 8, wherein said second plate member has a second pin hole proximate to one end thereof, and is connected to said first connecting portion by extending said connecting pin through said second pin hole.

10. The adsorption positioning device as claimed in claim 2, wherein each of said platen units further includes a sealing member connected between said cover portion and said table.
